(19) United States
(12) Patent Application Publication
(10) Pub. No.: US 2026/0113324 A1
(43) Pub. Date: Apr. 23, 2026

(54) SYSTEMS AND METHODS FOR RESETTING AN AUTHENTICATION COUNTER

(71) Applicant: Capital One Services, LLC, McLean, VA (US)

(72) Inventors: James ZARAKAS, Centreville, VA (US); George BERGERON, Falls Church, VA (US); Adam VUKICH, Alexandria, VA (US)

(21) Appl. No.: 19/363,101

(22) Filed: Oct. 20, 2025

Related U.S. Application Data
(63) Continuation of application No. 17/403,470, filed on Aug. 16, 2021, now Pat. No. 12,495,042.

(51) Int. Cl. H04L 9/40; G06F 21/35; G06K 19/077; G06Q 20/34; G06Q 20/40; H04L 9/12

(52) U.S. Cl. CPC H04L 63/10; G06K 19/0772; G06Q 20/343; G06Q 20/356; G06Q 20/401; G06Q 20/4093; H04L 63/18; G06F 21/35; H04L 9/12

(57) ABSTRACT

Systems and methods for counter resynchronization can include one or more servers each including a memory and one or more processors. The one or more servers can be in data communication with a transmitting device. The one or more processors can be configured to determine one or more reset events. The one or more processors can be configured to generate a resync value. The one or more processors can be configured to transmit, via one or more scripts, the resync value to the transmitting device according to one or more prioritization factors and in response to the one or more reset events. The one or more processors can be configured to replace the counter value with the resync value in accordance with the one or more prioritization factors.

### CROSS-REFERENCE TO RELATED APPLICATIONS

This patent application is a continuation of U.S. patent application Ser. No. 17/403,470, filed Aug. 16, 2021. The contents of the above-referenced patent application are incorporated by reference in its entirety.

### FIELD OF THE DISCLOSURE

The present disclosure relates to systems and methods for resetting an authentication counter.

### BACKGROUND

Card-based transactions are becoming increasingly common. These transactions often involve the use of a card in communication with a point of sale device, a server, or other device. It is necessary to protect such communications from interception and unauthorized access, and accordingly the communications are often encrypted.

One way to facilitate encryption is to use a counter in connection with one or more encryption algorithms. However, this requires the card and the point of sale device, server, or other device maintain synchronized counter values and a way to reset the counter if it becomes unsynchronized. Without effectively resetting an internal authentication counter of a card, desynchronization issues exist when conducting transactions and verifying expected counter adjustments, which can lead to unauthorized access, fraudulent activity, such as misuse of the card, and increased risk, thereby resulting in reduced security. Even prompting a user that the counter will be reset is susceptible to security vulnerabilities insofar as a malicious attacker receives advance notice of the counter reset.

These and other deficiencies exist. Accordingly, there is a need for systems and methods for resetting an authentication counter that overcome these deficiencies in a secure and reliable manner without prompting a user that the counter will be reset.

### SUMMARY OF THE DISCLOSURE

Embodiments of the present disclosure provide a counter resynchronization system, including one or more servers each including a memory and one or more processors. The one or more servers can be in data communication with a transmitting device. The one or more processors can be configured to determine one or more reset events. The one or more processors can be configured to generate a resync value. The one or more processors can be configured to transmit, via one or more scripts, the resync value to the transmitting device according to one or more prioritization factors and in response to the one or more reset events. The one or more processors can be configured to replace the counter value with the resync value in accordance with the one or more prioritization factors.

Embodiments of the present disclosure provide a method of counter resynchronization. The method can include generating, by one or more processors, a first counter value. The method can include determining, by the one or more processors, a plurality of events. The method can include transmitting, by the one or more processors, the first counter value via one or more scripts to a transmitting device based on one or more prioritization factors and in response to the plurality of events. The method can include replacing, by the one or more processors, a second counter value of the transmitting device with the first counter value in accordance with the one or more prioritization factors.

Embodiments of the present disclosure provide a computer readable non-transitory medium comprising computer-executable instructions that are executed on a processor and comprising the steps of: determining one or more reset events; generating a resync value; triggering, based on the one or more reset events, a plurality of corrective actions responsive to the one or more reset events; transmitting the resync value to a transmitting device according to one or more prioritization factors; replacing a counter value of the transmitting device with the resync value; and validating successful execution of the one or more scripts.

### BRIEF DESCRIPTION OF THE DRAWINGS

Various embodiments of the present disclosure, together with further objects and advantages, can best be understood by reference to the following description taken in conjunction with the accompanying drawings.

FIG. 1 depicts a counter resynchronization system according to an exemplary embodiment.

FIG. 2A is an illustration of a contactless card according to an exemplary embodiment.

FIG. 2B is an illustration of a contact pad of a contactless card according to an exemplary embodiment.

FIG. 3 depicts a method of counter resynchronization according to an exemplary embodiment.

FIG. 4 depicts a method of prioritization of counter resynchronization according to an exemplary embodiment.

FIG. 5 depicts a method of a validation process of counter resynchronization according to an exemplary embodiment.

### DETAILED DESCRIPTION

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

Benefits of the disclosed systems and methods for maintaining and verifying synchronized counter values include improved security to protect communications from interception and unauthorized access. By doing so, the risk of fraudulent activity, such as misuse of the card or an account associated with the card, can be reduced.

Further, the need to prompt a user that the counter will be reset is susceptible to security vulnerabilities insofar as a malicious attacker receives advance notice of the counter reset, and by eliminating this need this risk can be reduced, while simultaneously avoiding counter desynchronization. In addition, by removing the user from involvement in maintaining and synchronizing counter values, user experience and transaction efficiency can be improved.

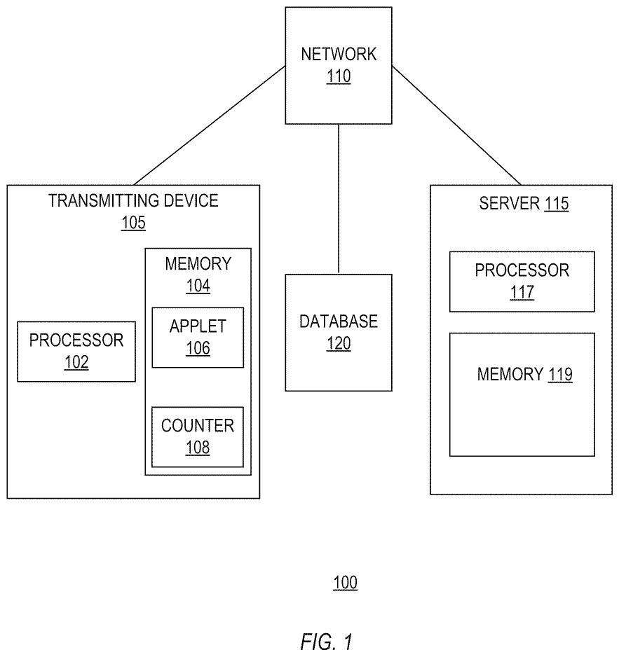

FIG. 1 illustrates a counter resynchronization system 100. The counter resynchronization system 100 can comprise a transmitting device 105, a network 110, a server 115, and a database 120. Although FIG. 1 illustrates single instances of components of system 100, system 100 can include any number of components.

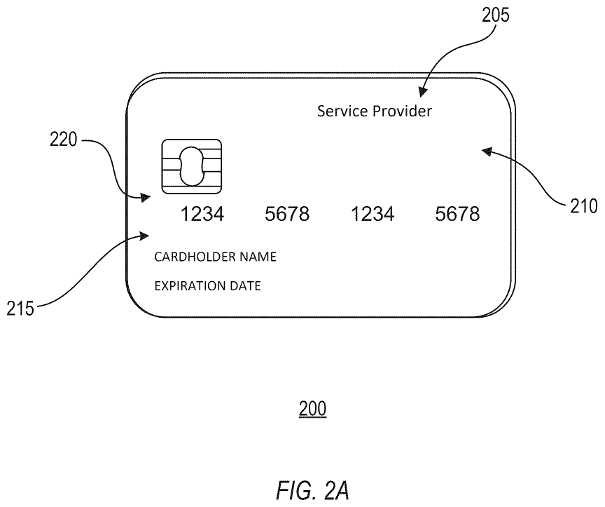

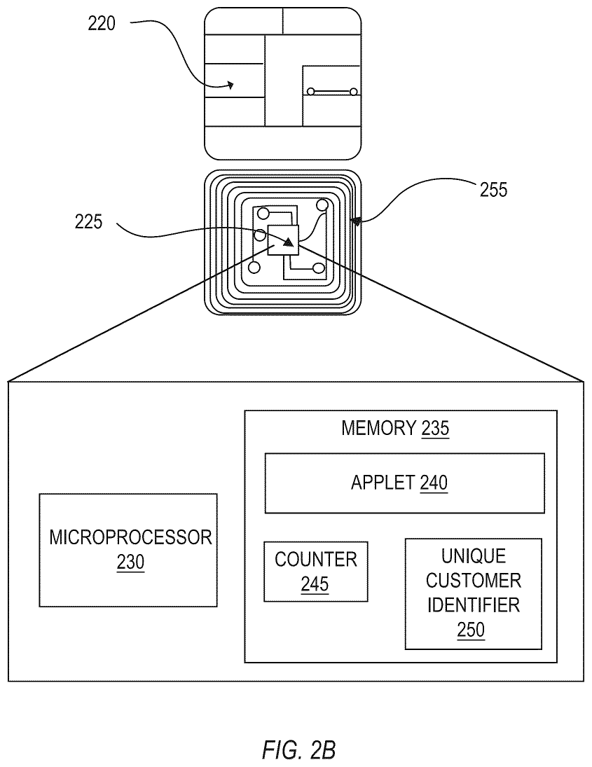

System 100 can include a transmitting device 105. The transmitting device 105 can comprise a contactless card, a contact-based card, a network-enabled computer, or other device described herein. As referred to herein, a network-enabled computer can include, but is not limited to a computer device, or communications device including, e.g., a server, a network appliance, a personal computer, a workstation, a phone, a handheld PC, a personal digital assistant, a contactless card, a contact-based card, a thin client, a fat client, an Internet browser, or other device. As further explained below in FIGS. 2A-2B, transmitting device 105 can include one or more processors 102, and memory 104. Memory 104 can include one or more software applications or applets 106 configured to perform the functions and operations described herein. Memory 104 can include one or more counters 108. Each counter 108 can include a counter value. Transmitting device 105 can be in data communication with any number of components of system 100. For example, transmitting device 105 can transmit data via network 110 to server 115. Transmitting device 105 can transmit data via network 110 to database 120. In some examples, transmitting device 105 can be configured to transmit data via network 110 after entry into one or more communication fields of any device. Without limitation, each entry can be associated with a tap, a swipe, a wave, and/or any combination thereof.

System 100 can include a network 110. In some examples, network 110 can be one or more of a wireless network, a wired network or any combination of wireless network and wired network, and can be configured to connect to any one of components of system 100. For example, transmitting device 105 can be configured to connect to server 115 via network 110. In some examples, network 110 can include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, network 110 can include, without limitation, telephone lines, fiber optics, IEEE Ethernet 902.3, a wide area network, a wireless personal area network, a LAN, or a global network such as the Internet. In addition, network 110 can support an Internet network, a wireless communication network, a cellular network, or the like, or any combination thereof. Network 110 can further include one network, or any number of the exemplary types of networks mentioned above, operating as a stand-alone network or in cooperation with each other. Network 110 can utilize one or more protocols of one or more network elements to which they are communicatively coupled. Network 110 can translate to or from other protocols to one or more protocols of network devices. Although network 110 is depicted as a single network, it should be appreciated that according to one or more examples, network 110 can comprise a plurality of interconnected networks, such as, for example, the Internet, a service provider's network, a cable television network, corporate networks, such as credit card association networks, and home networks.

System 100 can include one or more servers 115. In some examples, server 115 can include one or more processors 117 coupled to memory 119. Server 115 can be configured as a central system, server or platform to control and call various data at different times to execute a plurality of workflow actions. Server 115 can be configured to connect to transmitting device 105. Server 115 can be in data communication with the applet 106. For example, a server 115 can be in data communication with applet 106 via one or more networks 110. Transmitting device 105 can be in communication with one or more servers 115 via one or more networks 110, and can operate as a respective front-end to back-end pair with server 115. Transmitting device 105 can transmit, for example from applet 106 executing thereon, one or more requests to server 115. The one or more requests can be associated with retrieving data from server 115. Server 115 can receive the one or more requests from transmitting device 105. Based on the one or more requests from applet 106, server 115 can be configured to retrieve the requested data. Server 115 can be configured to transmit the received data to applet 106, the received data being responsive to one or more requests.

In some examples, server 115 can be a dedicated server computer, such as a bladed server, or can be a personal computer, laptop computer, notebook computer, palm top computer, network computer, mobile device, wearable device, or any processor-controlled device capable of supporting the system 100. While FIG. 1 illustrates a single server 115, it is understood that other embodiments can use multiple servers or multiple computer systems as necessary or desired to support the users and can also use back-up or redundant servers to prevent network downtime in the event of a failure of a particular server.

Server 115 can include an application (e.g., a software application, an applet, a script) comprising instructions for execution thereon. For example, the application can comprise instructions for execution on the server 115. The application can be in communication with any components of system 100. For example, server 115 can execute one or more applications that enable, for example, network and/or data communications with one or more components of system 100, transmit and/or receive data, and perform the functions and operations described herein. Without limitation, server 115 can be a network-enabled computer. Server 115 also can be a mobile device; for example, a mobile device can include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 115 can include processing circuitry and can contain additional components, including processors, memories, error and parity/CRC checkers, data encoders, anticollision algorithms, controllers, command decoders, security primitives and tamperproofing hardware, as necessary to perform the functions described herein. The server 115 can further include a display and input devices. The display can be any type of device for presenting visual information such as a computer monitor, a flat panel display, and a mobile device screen, including liquid crystal displays, light-emitting diode displays, plasma panels, and cathode ray tube displays. The input devices can include any device for entering information into the user's device that is available and supported by the user's device, such as a touch-screen, keyboard, mouse, cursor-control device, touch-screen, microphone, digital camera, video recorder or camcorder. These devices can be used to enter information and interact with the software and other devices described herein.

System 100 can include one or more databases 120. The database 120 can comprise a relational database, a non-relational database, or other database implementations, and any combination thereof, including a plurality of relational databases and non-relational databases. In some examples, the database 120 can comprise a desktop database, a mobile database, or an in-memory database. Further, the database 120 can be hosted internally by the transmitting device 105 or server 115, or the database 120 can be hosted externally to the transmitting device 105 and server 115, by a cloud-based platform, or in any storage device that is in data communication with the transmitting device 105 and server 115. In some examples, database 120 can be in data communication with any number of components of system 100. For example, server 115 can be configured to retrieve the requested data from the database 120 that is transmitted by applet 106. Server 115 can be configured to transmit the received data from database 120 to applet 106 via network 110, the received data being responsive to the transmitted one or more requests. In other examples, applet 106 can be configured to transmit one or more requests for the requested data from database 120 via network 110.

In some examples, exemplary procedures in accordance with the present disclosure described herein can be performed by a processing arrangement and/or a computing arrangement (e.g., computer hardware arrangement). Such processing/computing arrangement can be, for example entirely or a part of, or include, but not limited to, a computer/processor that can include, for example one or more microprocessors, and use instructions stored on a computer-accessible medium (e.g., RAM, ROM, hard drive, or other storage device). For example, a computer-accessible medium can be part of the memory of the transmitting device 105, server 115, and/or database 120, or other computer hardware arrangement.

In some examples, a computer-accessible medium (e.g., as described herein above, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. In addition or alternatively, a storage arrangement can be provided separately from the computer-accessible medium, which can provide the instructions to the processing arrangement so as to configure the processing arrangement to execute certain exemplary procedures, processes, and methods, as described herein above, for example.

The one or more processors 117 can be configured to determine one or more reset events. For example, at least one of the one or more reset events can comprise exceeding a first threshold differential between the counter value and a resync value. The first threshold differential can comprise a value within a first range. One of the one or more reset events can comprise exceeding a second threshold differential between the counter value and a resync value. The second threshold differential can comprise a value within a second range. The second threshold differential can be greater than the first threshold differential. Without limitation, the first threshold differential can comprise a value of 5 that is within a range of 1 to 10. Without limitation, the second threshold differential can comprise a value of 50 that is within a range of 1 to 100. For example, there can be an instance in which the counter value of the transmitting device 105 is off by a 5 or less, which is different than an instance in which the counter value of the transmitting device 105 is off by 100 or more, thereby leading to desynchronization issues between the card and the one or more processors 117. Depending on the threshold differential value, the counter value of the transmitting device 105 can be reset by the one or more processors 117 at the next data communication with a device, such as a point of sales device, as further explained below.

In another example, one of the one or more reset events, as determined by the one or more processors 117, can comprise counter overflow associated with the resync value and the counter value. For example, if the one or more processors 117 determine that the counter value of the transmitting device 105 is approaching or will imminently approach counter overflow such that a large value is about to reach, the one or more processors 117 can be configured to determine an associated reset event so as to transmit the resync value to the transmitting device 105, in which the counter value of the transmitting device 105 is replaced with the resync value received from the one or more processors 117. The one or more processors 117 can be configured to assign one or more integer values associated with the counter value. For example, a 2 byte unsigned integer can comprise a minimum value of 0 and a maximum value of 65,535. In one example, the transmitting device 105 can have a lifespan of any time duration, including but not limited to 1 day, 1 month, 1 year, 2 years, 5 years, etc. The counter value of the transmitting device 105 can be configured to increment any number, or predetermine threshold number, of times, such as 4 counter increments for the given time duration. For an exemplary 5 year time duration, this would yield 7,300 counter increments over the lifespan of the transmitting device 105. In this manner, the counter value of the transmitting device 105 can be selected and/or adjusted to increment so as to avoid approaching the maximum value and/or counter increments.

In response to the one or more reset events, the one or more processors 117 can be configured to transmit one or more values to the transmitting device 105. For example, the one or more processors 117 can be configured to transmit, via one or more scripts, the one or more values to the transmitting device 105. The one or more scripts can be transmitted as part of an authorization response. For example, the one or more scripts can be sent by an issuer of the transmitting device 105 in a transaction authorization response. The one or more scripts can be generated and/or transmitted on a periodic or predetermined schedule in order to resync counter values that have not been replaced for a predetermined time, including but not limited to any number of seconds, minutes, hours, days, weeks, months, years, etc. In one example, the one or more scripts can be transmitted every day. In another example, the one or more scripts can be transmitted to resync counter values that are 30 days old. Without limitation, the one or more scripts can be configured to update and change one or more values, such as a counter value, of the transmitting device 105. In this manner, the changes can improve the risk functions of an applet on the transmitting device 105 and reduce or prevent fraudulent activity during the lifetime of the transmitting device 105. In some examples, server 115 can store the one or more scripts. In other examples, the one or more scripts can be retrieved from a database, such as database 120.

For example, the one or more processors 117 can be configured to transmit a resync value to the transmitting device 105. In some examples, the one or more processors 117 can be configured to generate the one or more values. The resync value can include, for example, 2 bytes of unsigned integer with a maximum value of 65,535. For example, the one or more processors 117 can be configured to generate the resync value. The one or more processors 117 can be configured to transmit the resync value through a channel. In some examples, the channel can comprise an out-of-band channel.

In some examples, the one or more processors 117 can be configured to periodically generate the resync value and/or transmit the resync value to the transmitting device 105. In some examples, the one or more processors 117 can be configured to reset the counter value of the transmitting device 105 at a predetermined time, such as every second, minute, hour, day, week, month, year, and/or any combination thereof by replacing the counter value with the resync value.

In other examples, the counter value of the transmitting device 105 can be replaced with the resync value received from the one or more processors 117 at the next connection with a device, such as contact-based connection between the transmitting device 105 and a point of sale device. Since the counter of the transmitting device 105 is immutable, this approach improves upon existing solutions in which only the counter on the server 115 is updated to match that of the transmitting device 105. In this example, the counter value of the transmitting device 105 can be reset based on the determination of the threshold differential value. For example, depending on the threshold differential value, such as the counter value of the transmitting device 105 being off by 50 instead of 5, the counter value of the transmitting device 105 can be reset at the next data communication with a device, such as a transaction between the transmitting device 105 and a point of sales device. In some examples, the contact-based connection can comprise the insertion of the transmitting device 105 into the point of sales device. In this manner, the user does not need to be prompted by the device in order to replace the counter value of the transmitting device 105 with the resync value generated and/or transmitted by the one or more processors 117. In other examples, the counter value of the transmitting device 105 can be replaced with the resync value received from the one or more processors 117 at the next connection with a device, such as contactless-based connection between the transmitting device 105 and a point of sales device. The transmitting device 105 can be configured to receive the resync value from the one or more processors 117. For example, the transmitting device 105 can be configured to periodically receive the resync value from the one or more processors 117. In some examples, the transmitting device 105 and the one or more processors 117 can be configured to replace the counter value with the resync value. For example, the counter value of the transmitting device 105 can be overridden by the supplied resync value at each instance the transmitting device 105 is inserted into a device, such as a point of sale device. In this manner, desynchronization of the counter values between the one or more processors 117 and transmitting device 105 is avoided.

In some examples, the one or more processors 117 can be configured to prioritize when the resync value should be transmitted to replace the counter value of the transmitting device 105. The prioritization can be based on one or more prioritization factors. For example, at least one of the prioritization factors can comprise a threshold differential in determining whether a transmitting device 105, such as a particular transmitting device, is given preferential treatment to replace its counter value with the resync value from the one or more processors 117. The one or more processors 117 can be configured to trigger a reset of the counter value of the transmitting device 105 if the counter value yields a desired value. In this manner, prioritization of resyncing the counter value with the one or more processors 117 is based on a reactive approach, since the one or more processors 117 can be configured to determine if the threshold differential is reached, such as the counter value being off by 500 as opposed to the counter value being off by 5.

In another example, at least one of the prioritization factors can comprise the one or more processors 117 configured to trigger a reset of the counter value of the transmitting device 105 after a predetermined time, such as, without limitation, after two weeks or three months. In this manner, prioritization of resyncing the counter value with the one or more processors 117 is based on a proactive approach. In some examples, the one or more processors 117 can be configured to trigger a reset of the counter value of the transmitting device 105 if the transmitting device 105 has been issued within, e.g., the past 8 months. In another example, the one or more processors 117 can be configured to trigger a reset of the counter value of the transmitting device 105 if the counter value has not been reset after, e.g., 4 months.

The one or more processors 117 can be configured to perform a validation process that the resync value was transmitted, received, and executed to replace the counter value of the transmitting device 105 with the resync value. For example, the validation process can comprise receiving an outcome of execution status of the one or more scripts. In some examples, the validation process can include receiving a confirmation indicative of successful execution of the one or more scripts. For example, the one or more processors 117 can be configured to receive, from the transmitting device 105, that the transmitting device 105 received the one or more scripts and executed the one or more scripts. In other examples, the validation process can include determining or receiving a confirmation indicative of unsuccessful execution of the one or more scripts. If the confirmation is indicative of an unsuccessful execution of the one or more scripts, the one or more scripts can be re-transmitted and/or re-executed up to and including a predetermined number of times before the entire process times out. In some examples, after reaching a predetermined number of failures of the script execution, the transmitting device 105 can be locked and can be substituted by issuance of a replacement transmitting device. In another example, the one or more processors 117 can be configured to determine that the one or more scripts successfully executed.

In response to the one or more reset events, the one or more processors 117 and/or database 120 can be configured to trigger one or more corrective actions. For example, the one or more corrective actions can include at least one selected from the group of blocking data communication with the transmitting device 105 or otherwise disabling data communication, disabling one or more accounts associated with a user, logging one or more records, and/or any combination thereof, and can be in response to any of the one or more reset events. In some examples, the one or more accounts associated with a user can be disabled for a predetermined period of time, including but not limited to seconds, minutes, hours, days, weeks, months, years, and/or any combination thereof. In other examples, the one or more accounts associated with a user can be disabled for certain transactions and merchants, including but not limited to one or more merchants located within a predetermined geographic range. In some examples, the logging of one or more records can be associated with flagging the one or more reset events in a database. Without limitation, the one or more processors 117 and/or database 120 can be configured to monitor the flagged one or more reset events in order to determine if and when a new resync value should be generated, if and when the resync value should be transmitted to the transmitting device 105, and/or if and when the transmitting device 105 should be deactivated. The one or more processors 117 and/or database 120 can be configured to determine if and when the transmitting device 105 should be reactivated.

FIG. 2A illustrates one or more transmitting devices 200. Transmitting device 200 can reference the same or similar components of transmitting device 105, as explained above with respect to FIG. 1. Although FIGS. 2A and 2B illustrate single instances of components of transmitting device 200, any number of components can be utilized.

Transmitting device 200 can be configured to communicate with one or more components of system 100. Transmitting device 200 can comprise a contact-based card or contactless card, which can comprise a payment card, such as a credit card, debit card, or gift card, issued by a service provider 205 displayed on the front or back of the transmitting device 200. In some examples, the transmitting device 200 is not related to a payment card, and can comprise, without limitation, an identification card, a membership card, and a transportation card. In some examples, the payment card can comprise a dual interface contactless payment card. The transmitting device 200 can comprise a substrate 210, which can include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the transmitting device 200 can have physical characteristics compliant with the ID-1 format of the ISO/IEC 7810 standard, and the contactless card can otherwise be compliant with the ISO/IEC 14443 standard. However, it is understood that the transmitting device 200 according to the present disclosure can have different characteristics, and the present disclosure does not require a contactless card to be implemented in a payment card.

The transmitting device 200 can also include identification information 215 displayed on the front and/or back of the card, and a contact pad 220. The contact pad 220 can be configured to establish contact with another communication device, including but not limited to a user device, smart phone, laptop, desktop, or tablet computer. The transmitting device 200 can also include processing circuitry, antenna and other components not shown in FIG. 2A. These components can be located behind the contact pad 220 or elsewhere on the substrate 210. The transmitting device 200 can also include a magnetic strip or tape, which can be located on the back of the card (not shown in FIG. 2A).

As illustrated in FIG. 2B, the contact pad 220 of FIG. 2A can include processing circuitry 225 for storing and processing information, including a processor 230, such as a microprocessor, and a memory 235. It is understood that the processing circuitry 225 can contain additional components, including processors, memories, error and parity/CRC checkers, data encoders, anticollision algorithms, controllers, command decoders, security primitives and tamperproofing hardware, as necessary to perform the functions described herein.

The memory 235 can be a read-only memory, write-once read-multiple memory or read/write memory, e.g., RAM, ROM, and EEPROM, and the transmitting device 200 can include one or more of these memories. A read-only memory can be factory programmable as read-only or one-time programmable. One-time programmability provides the opportunity to write once then read many times. A write once/read-multiple memory can be programmed at a point in time after the memory chip has left the factory. Once the memory is programmed, it cannot be rewritten, but it can be read many times. A read/write memory can be programmed and re-programed many times after leaving the factory. It can also be read many times.

The memory 235 can be configured to store one or more applets 240, one or more counters 245, and a customer identifier 250. The one or more applets 240 can comprise one or more software applications configured to execute on one or more contactless cards, such as Java Card applet, and perform the functions and operations described herein. However, it is understood that applets 240 are not limited to Java Card applets, and instead can be any software application operable on contactless cards or other devices having limited memory. The one or more counters 245 can comprise a numeric counter sufficient to store an integer. The customer identifier 250 can comprise a unique alphanumeric identifier assigned to a user of the transmitting device 200, and the identifier can distinguish the user of the contactless card from other contactless card users. In some examples, the customer identifier 250 can identify both a customer and an account assigned to that customer and can further identify the contactless card associated with the customer's account.

The processor and memory elements of the foregoing exemplary embodiments are described with reference to the contact pad, but the present disclosure is not limited thereto. It is understood that these elements can be implemented outside of the contact pad 220 or entirely separate from it, or as further elements in addition to processor 230 and memory 235 elements located within the contact pad 220.

In some examples, the transmitting device 200 can comprise one or more antennas 255. The one or more antennas 255 can be placed within the transmitting device 200 and around the processing circuitry 225 of the contact pad 220. For example, the one or more antennas 255 can be integral with the processing circuitry 225 and the one or more antennas 255 can be used with an external booster coil. As another example, the one or more antennas 255 can be external to the contact pad 220 and the processing circuitry 225.

In an embodiment, the coil of transmitting device 200 can act as the secondary of an air core transformer. The terminal can communicate with the transmitting device 200 by cutting power or amplitude modulation. The transmitting device 200 can infer the data transmitted from the terminal using the gaps in the contactless card's power connection, which can be functionally maintained through one or more capacitors. The transmitting device 200 can communicate back by switching a load on the contactless card's coil or load modulation. Load modulation can be detected in the terminal's coil through interference.

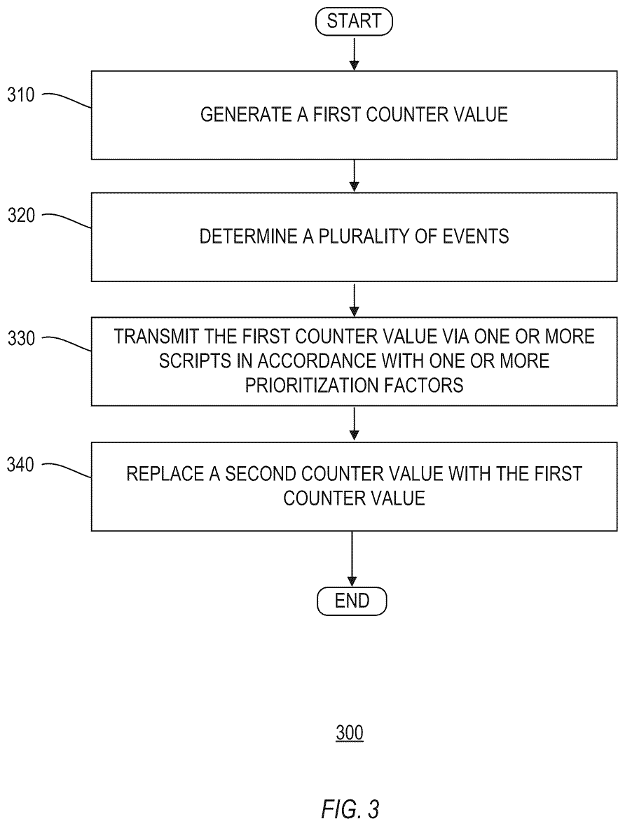

FIG. 3 depicts a method 300 of counter resynchronization. FIG. 3 can reference the same or similar components of system 100, and transmitting device 200 of FIG. 2A and FIG. 2B.

At block 310, the method 300 can include generating, by one or more processors, a first counter value. The one or more processors can be a part of a server. In some examples, the first counter value can comprise a resync value. The resync value can include, for example, 2 bytes of unsigned integer with a maximum value of 65,535. For example, the one or more processors can be configured to generate the resync value.

At block 320, the method 300 can include determining, by the one or more processors, a plurality of events. For example, at least one of the reset events can comprise exceeding a first threshold differential between the counter value and a resync value. The first threshold differential can comprise a value within a first range. At least one of the reset events can comprise exceeding a second threshold differential between the counter value and a resync value. The second threshold differential can comprise a value within a second range. The second threshold differential can be greater than the first threshold differential. Without limitation, the first threshold differential can comprise a value of 5 that is within a range of 1 to 10. Without limitation, the second threshold differential can comprise a value of 50 that is within a range of 1 to 100. For example, there can be an instance in which the counter value of the transmitting device is off by a 5 or less, which is different than an instance in which the counter value of the transmitting device is off by 100 or more, thereby leading to desynchronization issues between the card and the one or more processors. Depending on the threshold differential value, the counter can be reset by the one or more processors at the next data communication with a device, such as a point of sale device, as further explained below.

In another example, at least one of the reset events, as determined by the one or more processors, can comprise counter overflow associated with the resync value and the counter value. For example, if the one or more processors determine that the counter value of the transmitting device is approaching or will imminently approach counter overflow such that a large value is about to reach, the one or more processors can be configured to determine an associated reset event so as to transmit the resync value to the transmitting device, in which the counter value of the transmitting device is replaced with the resync value received from the one or more processors. The one or more processors can be configured to assign one or more integer values associated with the counter value. For example, a 2 byte unsigned integer can comprise a minimum value of 0 and a maximum value of 65,535. In one example, the transmitting device can have a lifespan of any time duration, including but not limited to 1 day, 1 month, 1 year, 2 years, 5 years, etc. The counter value of the transmitting device can be configured to increment any number, or predetermine threshold number, of times, such as 4 counter increments for the given time duration. For an exemplary 5 year time duration, this would yield 7,300 counter increments over the lifespan of the transmitting device. In this manner, the counter value of the transmitting device can be selected and/or adjusted to increment so as to avoid approaching the maximum value and/or counter increments.

At block 330, the method 300 can include transmitting, by the one or more processors, the first counter value via one or more scripts to a transmitting device based on one or more prioritization factors and in response to the plurality of events. In response to the one or more reset events, the one or more processors can be configured to transmit one or more values to the transmitting device. For example, the one or more processors can be configured to transmit, via one or more scripts, the one or more values to the transmitting device. The one or more scripts can be transmitted as part of an authorization response. For example, the one or more scripts can be sent by an issuer of the transmitting device in a transaction authorization response. The one or more scripts can be generated and/or transmitted on a periodic or predetermined schedule in order to resync counter values that have not been replaced for a predetermined time, including but not limited to any number of seconds, minutes, hours, days, weeks, months, years, etc. In one example, the one or more scripts can be transmitted every day. In another example, the one or more scripts can be transmitted to resync counter values that are 30 days old. Without limitation, the one or more scripts can be configured to update and change one or more values, such as a counter value, of the transmitting device. In this manner, the changes can improve the risk functions of an applet on the transmitting device and reduce or prevent fraudulent activity during the lifetime of the transmitting device. In some examples, server can store the one or more scripts. In other examples, the one or more scripts can be retrieved from a database, such as database.

For example, the one or more processors can be configured to transmit a resync value to the transmitting device. In some examples, the one or more processors can be configured to generate the one or more values. The one or more processors can be configured to transmit the resync value through a channel. In some examples, the channel can comprise an out-of-band channel.

At block 340, the method 300 can include replacing, by the one or more processors, a second counter value with the first counter value in accordance with the one or more prioritization factors. The second counter value can comprise a counter value of the transmitting device. In some examples, the one or more processors can be configured to periodically generate the resync value and/or transmit the resync value to the transmitting device. In some examples, the one or more processors can be configured to reset the counter value of the transmitting device at a predetermined time, such as every second, minute, hour, day, week, month, year, and/or any combination thereof by replacing the counter value with the resync value.

In other examples, the counter value of the transmitting device can be replaced with the resync value received from the one or more processors at the next connection with a device, such as contact-based connection between the transmitting device and a point of sales device. Since the counter of the transmitting device is immutable, this approach improves upon existing solutions in which only the counter on the server is updated to match that of the transmitting device. In this example, the counter value of the transmitting device can be reset based on the determination of the threshold differential value. For example, depending on the threshold differential value, such as the counter value of the transmitting device being off by 50 instead of 5, the counter value of the transmitting device can be reset at the next data communication with a device, such as a transaction between the transmitting device and a point of sales device. In some examples, the contact-based connection can comprise the insertion of the transmitting device into the point of sales device. In this manner, the user does not need to be prompted by the device in order to replace the counter value of the transmitting device with the resync value generated and/or transmitted by the one or more processors. In other examples, the counter value of the transmitting device can be replaced with the resync value received from the one or more processors at the next connection with a device, such as contactless-based connection between the transmitting device and a point of sales device.

The transmitting device can be configured to receive the resync value from the one or more processors. For example, the transmitting device can be configured to periodically receive the resync value from the one or more processors. In some examples, the transmitting device and the one or more processors can be configured to replace the counter value with the resync value. For example, the counter value of the transmitting device can be overridden by the supplied resync value at each instance the transmitting device is inserted into a device, such as a point of sale device. In this manner, desynchronization of the counter values between the one or more processors and transmitting device is avoided.

In some examples, the one or more processors can be configured to prioritize when the resync value should be transmitted to replace the counter value of the transmitting device. The prioritization can be based on one or more factors. For example, at least one of factors can comprise a threshold differential in determining whether a particular transmitting device is given preferential treatment to replace its counter value with the resync value from the one or more processors. The one or more processors can be configured to trigger a reset of the counter value of the transmitting device if the counter value yields a desired value. In this manner, prioritization of resyncing the counter value with the one or more processors is based on a reactive approach, since the one or more processors can be configured to determine if the threshold differential is reached, such as the counter value being off by 500 as opposed to the counter value being off by 5.

In another example, at least one of the factors can comprise the one or more processors configured to trigger a reset of the counter value of the transmitting device after a predetermined time, such as, without limitation, after two weeks or three months. In this manner, prioritization of resyncing the counter value with the one or more processors is based on a proactive approach. In some examples, the one or more processors can be configured to trigger a reset of the counter value of the transmitting device if the transmitting device has been issued within, e.g., the past 8 months. In another example, the one or more processors can be configured to trigger a reset of the counter value of the transmitting device if the counter value has not been reset after, e.g., 4 months.

The one or more processors can be configured to perform a validation process that the resync value was transmitted, received, and executed to replace the counter value of the transmitting device with the resync value. For example, the validation process can comprise receiving an outcome of execution status of the one or more scripts. In some examples, the validation process can include receiving a confirmation indicative of successful execution of the one or more scripts. For example, the one or more processors can be configured to receive, from the transmitting device, that the transmitting device received the one or more scripts and executed the one or more scripts. In other examples, the validation process can include determining or receiving a confirmation indicative of unsuccessful execution of the one or more scripts. If the confirmation is indicative of an unsuccessful execution of the one or more scripts, the one or more scripts can be re-transmitted and/or re-executed up to and including a predetermined number of times before the entire process times out. In some examples, after reaching a predetermined number of failures of the script execution, the transmitting device can be locked and can be substituted by issuance of a replacement transmitting device. In another example, the one or more processors can be configured to determine that the one or more scripts successfully executed.

In response to the one or more reset events, the one or more processors and/or database can be configured to trigger one or more corrective actions. For example, the one or more corrective actions can include at least one selected from the group of blocking data communication with the transmitting device or otherwise disabling data communication, disabling one or more accounts associated with a user, logging one or more records, and/or any combination thereof, and can be in response to any of the one or more reset events. In some examples, the one or more accounts associated with a user can be disabled for a predetermined period of time, including but not limited to seconds, minutes, hours, days, weeks, months, years, and/or any combination thereof. In other examples, the one or more accounts associated with a user can be disabled for certain transactions and merchants, including but not limited to one or more merchants located within a predetermined geographic range. In some examples, the logging of one or more records can be associated with flagging the one or more reset events in a database. Without limitation, the one or more processors and/or database can be configured to monitor the flagged one or more reset events in order to determine if and when a new resync value should be generated, if and when the resync value should be transmitted to the transmitting device, and/or if and when the transmitting device should be deactivated. The one or more processors and/or database can be configured to determine if and when the transmitting device should be reactivated.

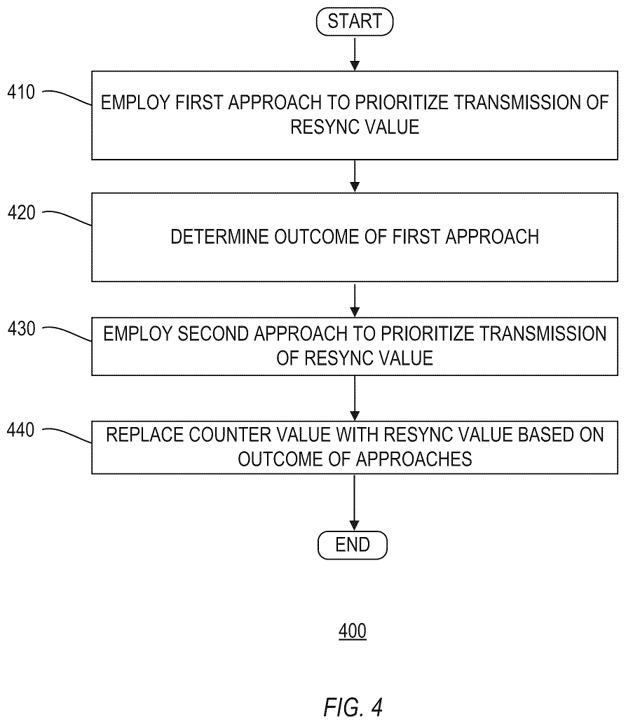

FIG. 4 depicts a method of a method of prioritization of counter resynchronization according to an exemplary embodiment. FIG. 4 can reference the same or similar components of system 100, transmitting device 200 of FIG. 2A and FIG. 2B, and method 300 of FIG. 3.

At block 410, the method 400 can include employing a first approach in prioritizing when the resync value is transmitted to replace the counter value. The first approach can comprise a reactive approach. As referred to herein, the reactive approach can include one or more processors configured to generate a determination and then respond or otherwise take action based on the determination. For example, one or more processors of a server can be configured to prioritize when the resync value should be transmitted to replace the counter value of the transmitting device. The prioritization can be based on one or more prioritization factors. For example, at least one of the prioritization factors can be associated with a threshold differential in determining whether a particular transmitting device is given preferential treatment to replace its counter value with the resync value from the one or more processors. The one or more processors can be configured to trigger a reset of the counter value of the transmitting device if the counter value yields a desired value. In this manner, prioritization of resyncing the counter value with the one or more processors is based on a reactive approach, since the one or more processors can be configured to trigger when the resync value should be transmitted after a determination of reaching a threshold differential, such as the counter value being off by 500 as opposed to the counter value being off by 5.

At block 420, the method 400 can include transmitting, based on the outcome of the first approach, the resync value. For example, this can include transmitting, by the one or more processors, the first counter value via one or more scripts to a transmitting device based on the results of the first approach and in response to the plurality of events. In response to the one or more reset events, the one or more processors can be configured to transmit one or more resync values to the transmitting device. For example, the one or more processors can be configured to transmit, via one or more scripts, the one or more resync values to the transmitting device. The one or more scripts can be transmitted as part of an authorization response. For example, the one or more scripts can be sent by an issuer of the transmitting device in a transaction authorization response. The one or more scripts can be generated and/or transmitted on a periodic or predetermined schedule in order to resync counter values that have not been replaced for a predetermined time, including but not limited to any number of seconds, minutes, hours, days, weeks, months, years, etc. In one example, the one or more scripts can be transmitted every day. In another example, the one or more scripts can be transmitted to resync counter values that are 30 days old. Without limitation, the one or more scripts can be configured to update and change one or more values, such as a counter value, of the transmitting device. In this manner, the changes can improve the risk functions of an applet on the transmitting device and reduce or prevent fraudulent activity during the lifetime of the transmitting device. In some examples, server can store the one or more scripts. In other examples, the one or more scripts can be retrieved from a database, such as database. For example, the one or more processors can be configured to transmit a resync value to the transmitting device. In some examples, the one or more processors can be configured to generate the one or more resync values. The one or more processors can be configured to transmit the resync value through a channel. In some examples, the channel can comprise an out-of-band channel.

At block 430, the method 400 can include employing a second approach in prioritizing when the resync value is transmitted to replace the counter value. The second approach can comprise a proactive approach. As referred to herein, the proactive approach can include one or more processors configured to take action based on, for example, expiration of a predetermined time. For example, at least one of the factors can comprise the one or more processors configured to trigger a reset of the counter value of the transmitting device after a predetermined time, such as, without limitation, after two weeks or three months. In this manner, prioritization of resyncing the counter value with the one or more processors is based on a proactive approach. In some examples, the one or more processors can be configured to trigger a reset of the counter value of the transmitting device if the transmitting device has been issued within, e.g., the past 8 months. In another example, the one or more processors can be configured to trigger a reset of the counter value of the transmitting device if the counter value has not been reset after, e.g., 4 months.

At block 440, the method 400 can include transmitting, based on the outcome of the second approach, the resync value. For example, this can include transmitting, by the one or more processors, the first counter value via one or more scripts to a transmitting device based on the results of the second approach and in response to the plurality of events. In response to the one or more reset events, the one or more processors can be configured to transmit one or more resync values to the transmitting device. For example, the one or more processors can be configured to the transmit, via one or more scripts, the one or more resync values to the transmitting device. The one or more scripts can be transmitted as part of an authorization response. For example, the one or more scripts can be sent by an issuer of the transmitting device in a transaction authorization response. The one or more scripts can be generated and/or transmitted on a periodic or predetermined schedule in order to resync counter values that have not been replaced for a predetermined time, including but not limited to any number of seconds, minutes, hours, days, weeks, months, years, etc. In one example, the one or more scripts can be transmitted every day. In another example, the one or more scripts can be transmitted to resync counter values that are 30 days old. Without limitation, the one or more scripts can be configured to update and change one or more values, such as a counter value, of the transmitting device. In this manner, the changes can improve the risk functions of an applet on the transmitting device and reduce or prevent fraudulent activity during the lifetime of the transmitting device. In some examples, server can store the one or more scripts. In other examples, the one or more scripts can be retrieved from a database, such as database. For example, the one or more processors can be configured to transmit a resync value to the transmitting device. In some examples, the one or more processors can be configured to generate the one or more resync values. The one or more processors can be configured to transmit the resync value through a channel. In some examples, the channel can comprise an out-of-band channel.

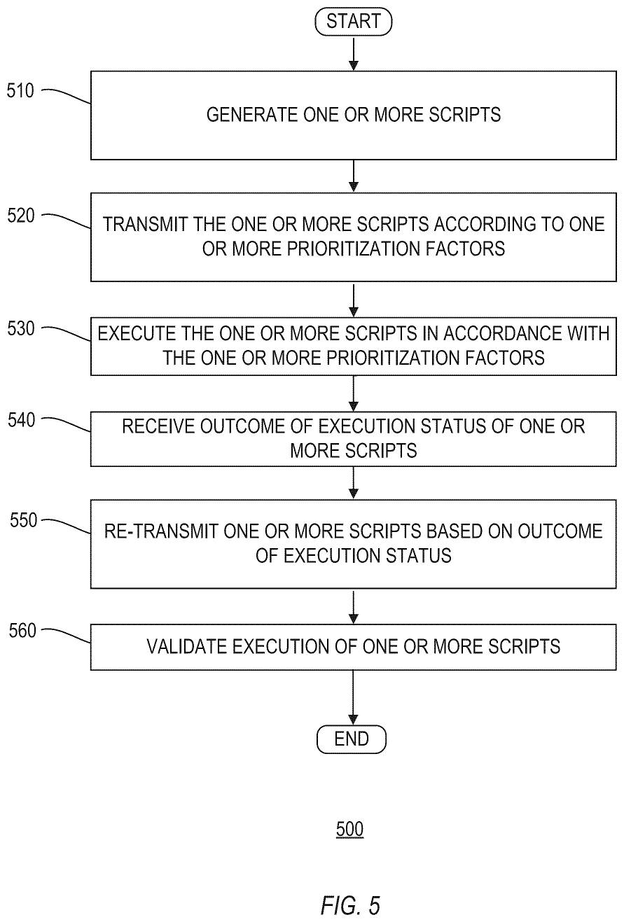

FIG. 5 depicts a validation method 500 of counter resynchronization according to an exemplary embodiment. FIG. 5 can reference the same or similar components of system 100, transmitting device 200 of FIG. 2A and FIG. 2B, method 300 of FIG. 3, and method 400 of FIG. 4.

At block 510, the method 500 can include generating one or more scripts. For example, one or more processors of a server can be configured to generate one or more scripts. Without limitation, the one or more scripts can be configured to update and change one or more values, such as a counter value, of the transmitting device. In this manner, the changes can improve the risk functions of an applet on the transmitting device and reduce or prevent fraudulent activity during the lifetime of the transmitting device. In some examples, server can store the one or more scripts. In other examples, the one or more scripts can be retrieved from a database.

At block 520, the method 500 can include transmitting the one or more scripts. For example, one or more processors of a server can be configured to transmit, via one or more scripts, the one or more values to the transmitting device. The one or more scripts can be transmitted as part of an authorization response. For example, the one or more scripts can be sent by an issuer of the transmitting device in a transaction authorization response. The one or more scripts can be generated and/or transmitted on a periodic or predetermined schedule in order to resync counter values that have not been replaced for a predetermined time, including but not limited to any number of seconds, minutes, hours, days, weeks, months, years, etc. In one example, the one or more scripts can be transmitted every day. In another example, the one or more scripts can be transmitted to resync counter values that are 30 days old.

At block 530, the method 500 can include executing the one or more scripts in accordance with one or more prioritization factors. For example, the transmitting device can be configured to receive and execute the one or more scripts in accordance with one or more prioritization factors. In some examples, the method 500 can include employing a first approach in prioritizing when the resync value is transmitted to replace the counter value. The first approach can comprise a reactive approach. For example, one or more processors of a server can be configured to prioritize when the resync value should be transmitted to replace the counter value of the transmitting device. The prioritization can be based on one or more factors. For example, at least one of factors can be associated with a threshold differential in determining whether a particular transmitting device is given preferential treatment to replace its counter value with the resync value from the one or more processors. The one or more processors can be configured to trigger a reset of the counter value of the transmitting device if the counter value yields a desired value. In this manner, prioritization of resyncing the counter value with the one or more processors is based on a reactive approach, since the one or more processors can be configured to determine if the threshold differential is reached, such as the counter value being off by 500 as opposed to the counter value being off by 5.

The method 500 can further include transmitting, based on the outcome of the first approach, the resync value. For example, this can include transmitting, by the one or more processors, the first counter value via one or more scripts to a transmitting device based on the results of the first approach and in response to the plurality of events. In response to the one or more reset events, the one or more processors can be configured to transmit one or more resync values to the transmitting device. For example, the one or more processors can be configured to transmit, via one or more scripts, the one or more resync values to the transmitting device. The one or more scripts can be transmitted as part of an authorization response. For example, the one or more scripts can be sent by an issuer of the transmitting device in a transaction authorization response. The one or more scripts can be generated and/or transmitted on a periodic or predetermined schedule in order to resync counter values that have not been replaced for a predetermined time, including but not limited to any number of seconds, minutes, hours, days, weeks, months, years, etc. In one example, the one or more scripts can be transmitted every day. In another example, the one or more scripts can be transmitted to resync counter values that are 30 days old. Without limitation, the one or more scripts can be configured to update and change one or more values, such as a counter value, of the transmitting device. In this manner, the changes can improve the risk functions of an applet on the transmitting device and reduce or prevent fraudulent activity during the lifetime of the transmitting device. In some examples, server can store the one or more scripts. In other examples, the one or more scripts can be retrieved from a database, such as database. For example, the one or more processors can be configured to transmit a resync value to the transmitting device. In some examples, the one or more processors can be configured to generate the one or more resync values. The one or more processors can be configured to transmit the resync value through a channel. In some examples, the channel can comprise an out-of-band channel.

The method 500 can further include employing a second approach in prioritizing when the resync value is transmitted to replace the counter value. The second approach can comprise a proactive approach. For example, at least one of the factors can comprise the one or more processors configured to trigger a reset of the counter value of the transmitting device after a predetermined time, such as, without limitation, after two weeks or three months. In this manner, prioritization of resyncing the counter value with the one or more processors is based on a proactive approach. In some examples, the one or more processors can be configured to trigger a reset of the counter value of the transmitting device if the transmitting device has been issued within, e.g., the past 8 months. In another example, the one or more processors can be configured to trigger a reset of the counter value of the transmitting device if the counter value has not been reset after, e.g., 4 months.

The method 500 can further include transmitting, based on the outcome of the second approach, the resync value. For example, this can include transmitting, by the one or more processors, the first counter value via one or more scripts to a transmitting device based on the results of the second approach and in response to the plurality of events. In response to the one or more reset events, the one or more processors can be configured to transmit one or more resync values to the transmitting device. For example, the one or more processors can be configured to the transmit, via one or more scripts, the one or more resync values to the transmitting device. The one or more scripts can be transmitted as part of an authorization response. For example, the one or more scripts can be sent by an issuer of the transmitting device in a transaction authorization response. The one or more scripts can be generated and/or transmitted on a periodic or predetermined schedule in order to resync counter values that have not been replaced for a predetermined time, including but not limited to any number of seconds, minutes, hours, days, weeks, months, years, etc. In one example, the one or more scripts can be transmitted every day. In another example, the one or more scripts can be transmitted to resync counter values that are 30 days old. Without limitation, the one or more scripts can be configured to update and change one or more values, such as a counter value, of the transmitting device. In this manner, the changes can improve the risk functions of an applet on the transmitting device and reduce or prevent fraudulent activity during the lifetime of the transmitting device. In some examples, server can store the one or more scripts. In other examples, the one or more scripts can be retrieved from a database, such as database. For example, the one or more processors can be configured to transmit a resync value to the transmitting device. In some examples, the one or more processors can be configured to generate the one or more resync values. The one or more processors can be configured to transmit the resync value through a channel. In some examples, the channel can comprise an out-of-band channel.

At block 540, the method 500 can include receiving an outcome of execution status of the one or more scripts. In some examples, the validation process can include receiving a confirmation indicative of successful execution of the one or more scripts. For example, the one or more processors can be configured to receive, from the transmitting device, that the transmitting device received the one or more scripts and executed the one or more scripts.

At block 550, the method 500 can include re-transmitting the one or more scripts in response to the outcome of execution status of the one or more scripts. For example, this process can include determining or receiving a confirmation indicative of unsuccessful execution of the one or more scripts. If the confirmation is indicative of an unsuccessful execution of the one or more scripts, the one or more scripts can be re-transmitted and/or re-executed up to and including a predetermined number of times before the entire method 500 times out. In some examples, after reaching a predetermined number of failures of the script execution, the transmitting device can be locked and can be substituted by issuance of a replacement transmitting device.

At block 560, the method 500 can include validating execution of the one or more scripts. The one or more processors can be configured to perform a validation process that the resync value was transmitted, received, and executed to replace the counter value of the transmitting device with the resync value. In this manner, the one or more processors can be configured to determine that the one or more scripts successfully executed, and can be configured to troubleshoot any of the above steps if and when the one or more scripts failed to generate, transmit, and/or execute.

It is further noted that the systems and methods described herein can be tangibly embodied in one of more physical media, such as, but not limited to, a compact disc (CD), a digital versatile disc (DVD), a floppy disk, a hard drive, read only memory (ROM), random access memory (RAM), as well as other physical media capable of data storage. For example, data storage can include random access memory (RAM) and read only memory (ROM), which can be configured to access and store data and information and computer program instructions. Data storage can also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files can be stored. The data storage of the network-enabled computer systems can include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which can include a flash array, a hybrid array, or a server-side product, enterprise storage, which can include online or cloud storage, or any other storage mechanism. Moreover, the figures illustrate various components (e.g., servers, computers, processors, etc.) separately. The functions described as being performed at various components can be performed at other components, and the various components can be combined or separated. Other modifications also can be made.

In the preceding specification, various embodiments have been described with references to the accompanying drawings. It will, however, be evident that various modifications and changes can be made thereto, and additional embodiments can be implemented, without departing from the broader scope of the invention as set forth in the claims that follow. The specification and drawings are accordingly to be regarded as an illustrative rather than restrictive sense.

1-20. (canceled)

21. A method for authentication counter resynchronization, comprising:
determining, by one or more processors, one or more reset events;
transmitting, by the one or more processors to a transmitting device, a first authentication counter value, wherein the transmission is responsive to the one or more reset events and based on one or more prioritization factors;
replacing, by the one or more processors responsive to a communication connection between the contactless card and a client device, a second authentication counter value stored by the transmitting device with the first authentication counter value; and
triggering, by the one or more processors in response to the one or more reset events, one or more corrective actions.

22. The method of claim 21, wherein the one or more corrective actions comprises blocking data communication with the transmitting device.

23. The method of claim 21, wherein the one or more corrective actions comprises disabling one or more user accounts.

24. The method of claim 23, wherein the one or more accounts are disabled for a predetermined period of time.

25. The method of claim 23, wherein the one or more accounts are disabled for certain transactions.

26. The method of claim 23, wherein the one or more accounts are disabled for one or more certain merchants.

27. The method of claim 26, wherein the one or more certain merchants comprises one or more merchants within a predetermined geographic range.

28. The method of claim 21, wherein the one or more corrective actions comprises logging one or more records.

29. The method of claim 28, wherein logging one or more records comprises flagging the one or more resent events in a database.

30. The method of claim 21, wherein a communicative connection between the transmitting device and a point of sale device triggers the replacement of the second authentication counter value.

31. An authentication counter resynchronization system, comprising:
one or more processors; and
a memory in data communication with the one or more processors and containing executable instructions,
wherein, upon execution by the one or more processors, the executable instructions cause the one or more processors to:
determine one or more reset events;
transmit, to a transmitting device, a first authentication counter value, wherein the transmission is responsive to the one or more reset events and based on one or more prioritization factors;
replace, responsive to a communication connection between the contactless card and a client device, a second authentication counter value stored by the transmitting device with the first authentication counter value; and
trigger, in response to the one or more reset events, one or more corrective actions.

32. The system of claim 31, wherein the one or more processors comprises part of a server.

33. The system of claim 31, wherein the one or more processors comprises part of a network-enabled computer.

34. The system of claim 31, wherein the one or more processors comprises part of a phone.

35. The system of claim 31, wherein the one or more processors comprises part of a wearable device.

36. The system of claim 31, wherein the executable instructions cause the one or more processors to transmit the first authentication value to the transmitting deice through an out-of-band channel.

37. The system of claim 31, wherein the executable instructions cause the one or more processors to periodically generate the first authentication counter value.

38. A non-transitory computer accessible medium containing executable instructions that, when executed by a computer hardware arrangement, cause the computer hardware arrangement to perform procedures comprising:
determining one or more reset events;
transmitting, to a transmitting device, a first authentication counter value, wherein the transmission is responsive to the one or more reset events and based on one or more prioritization factors;
replacing, responsive to a communication connection between the contactless card and a client device, a second authentication counter value stored by the transmitting device with the first authentication counter value; and
triggering, in response to the one or more reset events, one or more corrective actions.

39. The non-transitory computer accessible medium of claim 38, wherein at least one of the one or more reset events comprises a counter overflow associated with the first authentication counter value and the second authentication counter value.

40. The non-transitory computer accessible medium of claim 38, wherein at least one of the one or more prioritization factors comprises triggering a replacement of the second authentication counter value when a predetermined time has lapsed since the authentication counter value has been replaced.
